(19) United States
(12) Patent Application Publication
(10) Pub. No.: US 2026/0178327 A1
(43) Pub. Date: Jun. 25, 2026

(54) TRANSPOSE INSTRUCTIONS FOR 6-BIT FLOATING-POINT OPERATIONS

(71) Applicant: Advanced Micro Devices, Inc., Santa Clara, CA (US)

(72) Inventors: Shubra Marwaha, Santa Clara, CA (US); Bin He, Orlando, FL (US); Subramaniam Maiyuran, Folsom, CA (US)

(21) Appl. No.: 18/999,156

(22) Filed: Dec. 23, 2024

(51) Int. Cl. G06F 9/30

(52) U.S. Cl. CPC G06F 9/30036; G06F 9/30043; G06F 9/30098

(57) ABSTRACT

Techniques are disclosed for transposing and loading 6-bit floating-point matrix data into operations registers of a processing unit. A matrix comprising 6-bit floating-point data elements is received from memory, in which the matrix is stored in either a row-major or column-major layout. A matrix transposition loading operation is performed during the loading process, rearranging the matrix elements into a transposed layout (e.g., converting column-major to row-major). The transposed matrix is stored in operations registers for use in parallel processing tasks. The process may include caching partially stored data elements from memory and combining them with subsequently retrieved data to complete the transposition.

### BACKGROUND

Matrix operations are fundamental to a wide variety of computational tasks, including artificial intelligence (AI), machine learning (ML), and graphics rendering. These operations often require transposing matrices—rearranging data from a row-major layout to a column-major layout or vice versa—to align with hardware processing requirements. Such transpositions are particularly critical for matrix multiplications, where efficient alignment of data can significantly impact computational throughput.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system providing matrix transposition loading operations in accordance with some embodiments.

FIG. 2 illustrates an example of an initial layout in memory of a matrix comprising data elements formatted in a 6-bit floating-point data format, in accordance with some embodiments.

FIG. 3 illustrates a two-pass transposition and data-loading process for a matrix comprising FP6 data elements, in accordance with some embodiments.

FIG. 4 continues the example of FIGS. 2 and 3 with respect to the loading and transposition operation of the matrix 200, illustrating data reordering and repacking during the first pass of a matrix transposition process within a compute unit.

FIG. 5 continues the example of FIGS. 2-4 with respect to the matrix transposition loading operation of the matrix 200, in accordance with some embodiments.

FIG. 6 illustrates an operational routine for transposing and loading a matrix comprising FP6 data elements into operations registers for subsequent operations, in accordance with some embodiments.

### DETAILED DESCRIPTION

While power-of-two data formats, such as 4-bit floating-point (FP4) or 8-bit floating-point (FP8) formats, align well with existing memory and caching architectures, non-power-of-two formats, such as the 6-bit floating-point format (FP6), present unique challenges. These challenges stem from the inherent difficulty of aligning FP6 data with standard cache line sizes, leading to inefficiencies in memory access and data handling.

The FP6 format is particularly well-suited to AI and ML applications due to its unique balance between precision, computational efficiency, and memory usage. Many AI and ML tasks, especially those involving deep learning, tolerate reduced precision in numerical representation without a significant loss in accuracy. Neural network operations, such as matrix multiplications and convolutions, benefit from reduced precision formats because these models are inherently robust to minor errors introduced by lower precision. FP6 strikes an optimal balance by providing sufficient dynamic range and precision for these tasks while significantly reducing computational and memory overhead compared to higher precision formats like 16-bit floating-point (FP16) or 32-bit floating-point (FP32).

As AI and ML workloads increasingly leverage FP6 for its balance of precision and memory efficiency, the need for optimized transposition methods becomes paramount. Existing solutions fail to address the bottlenecks associated with FP6 transpositions, limiting the performance gains achievable in matrix computations. In various processor architectures, data transposition typically involves loading matrices from global or local memory into vector general-purpose registers (VGPRs) for processing. Conventional approaches to matrix transposition rely on software routines or external libraries to manipulate data layouts after loading into VGPRs. These methods typically require multiple move instructions and additional memory accesses, which introduce computational overhead and increase latency. Such inefficiencies are exacerbated when dealing with FP6 data due to its non-power-of-two nature, which complicates caching and alignment across memory boundaries.

Despite such complications, as noted above, the FP6 format aligns with emerging trends in optimizing AI and ML systems for a balance between accuracy and latency. While higher precision formats such as FP16 and FP32 may offer marginally better accuracy, the performance gains achieved by FP6, in terms of reduced cost and power consumption, may be more impactful for many practical AI and ML applications. These characteristics make FP6 an attractive choice for applications such as natural language processing, computer vision, and recommendation systems, where a balance between precision and efficiency facilitates better system performance.

There are additional advantages presented by the FP6 format. For example, the reduced bit-width of FP6 enhances computational efficiency by allowing more data elements to be processed in parallel within a fixed-width register or memory block. By enabling a higher degree of parallelism, FP6 improves the throughput of operations such as matrix multiplications, leading to faster computation and reduced power consumption. Furthermore, smaller data sizes also reduce the complexity of arithmetic operations, allowing hardware to execute these computations more rapidly. As another example, memory bandwidth and storage constraints may be alleviated by FP6's compact data representation; smaller data sizes enable more efficient transfer of information between memory and compute units, effectively increasing bandwidth utilization. Additionally, the reduced memory footprint of FP6 allows larger AI and ML models or higher batch sizes to be deployed within the same hardware constraints.

AI and ML workloads commonly involve matrix and tensor operations that do not necessarily require data formats with bit-widths that are powers of two. Thus, the FP6 format's non-power-of-two nature does not impede its utility in AI and ML tasks, in which it effectively supports the demands of modern computational models. The adoption of FP6 is further supported by the increasing prevalence of mixed precision training and inference. These approaches use lower precision formats, such as FP6, for most operations while reserving higher precision formats for critical computations, such as weight updates or accumulation.

Embodiments of techniques described herein are directed to efficient transposition and loading of matrices formatted in a 6-bit floating-point (FP6) data format within a processing unit. These techniques provide a matrix transposition loading operation, integrating the matrix transposition directly into the process of loading a matrix into operations registers (such as those associated with one or more compute units of the processing unit). This operation rearranges matrix elements from a first layout, such as row-major or column-major, into a second transposed layout during the loading process. By performing the transposition operation during loading, embodiments reduce the need for separate instructions and additional memory accesses, improving computational efficiency.

In some embodiments, the transposition operation accounts for alignment challenges associated with FP6 data, which generally spans non-power-of-two boundaries in memory. To address this, leftover elements resulting from partial storage across cache line boundaries are cached and combined with subsequently received data to complete the alignment during the transposition process. This ensures that the matrix is efficiently rearranged and stored in the operations registers, such as for subsequent processing by the compute units.

In certain embodiments, the described techniques are implemented within a parallel processor that includes a plurality of parallel processing clusters (PPCs), each having one or more compute units with associated operations registers. In various embodiments and scenarios, the operations registers may include, as non-limiting examples, general-purpose registers of the processing unit, vector general-purpose registers (VGPRs) of the processing unit, tensor cores of the processing unit, or some combination thereof. The operations registers provide localized storage for matrix data elements and facilitate the rearrangement of matrix elements during loading, eliminating the overhead of external memory interactions and optimizing data alignment for execution. By leveraging these features, the embodiments enable high-performance processing of FP6 matrices. In certain embodiments, the described matrix transposition loading operation is implemented as a processor-level command, facilitating efficient handling of FP6-formatted matrix data directly within the processing pipeline.

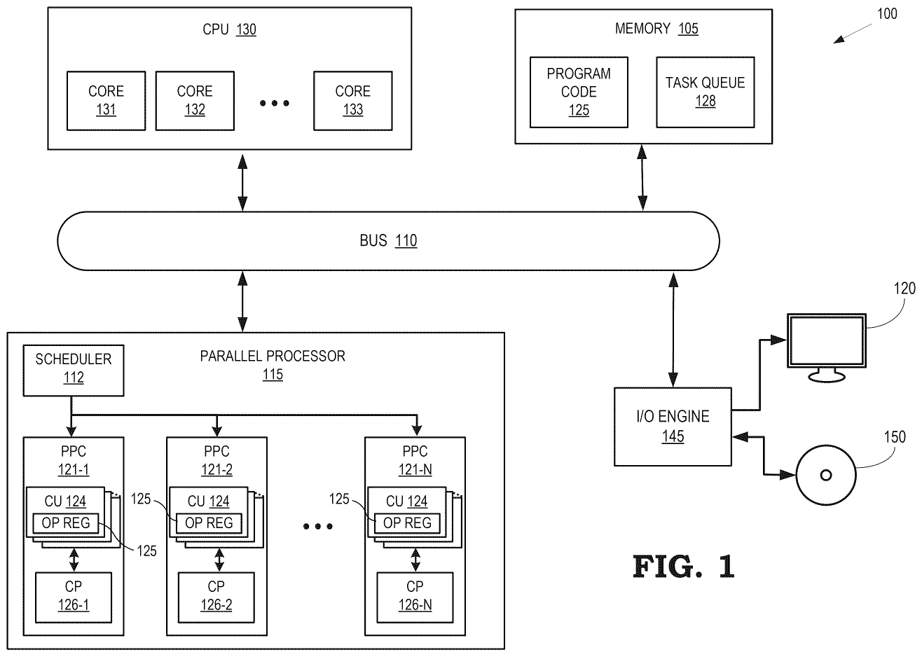

FIG. 1 is a block diagram of a processing system 100 providing matrix transposition loading operations according to some embodiments. The processing system 100 includes or has access to a memory 105 or other storage component that is implemented using a non-transitory computer readable medium such as a dynamic random-access memory (DRAM). However, in some cases, the memory 105 is implemented using other types of memory including static random-access memory (SRAM), nonvolatile RAM, and the like. The memory 105 is referred to as an external memory as it is implemented external to the processing units implemented in the processing system 100. The processing system 100 also includes a bus 110 to support communication between entities implemented in the processing system 100, such as the memory 105. Some embodiments of the processing system 100 include other buses, bridges, switches, routers, and the like, which are not shown in FIG. 1 in the interest of clarity.

The techniques described herein are, in different embodiments, employed at any of a variety of parallel processors (e.g., vector processors, graphics processing units (GPUs), general-purpose GPUs (GPGPUs), non-scalar processors, highly parallel processors, artificial intelligence (AI) processors, inference engines, machine learning processors, and other multithreaded processing units).

In the depicted embodiment, a parallel processor 115 renders images for presentation by the processing system 100 on a display 120. For example, the parallel processor 115 renders objects to produce values of pixels that are provided to the display 120, which uses the pixel values to display an image representing the rendered objects. However, the parallel processor 115 is also capable of executing software not directly involved in any graphics processing pipeline, such as machine learning applications and other advanced computing applications.

In order to provide the parallel processor 115 with the flexibility to execute tasks related to a graphics processing pipeline, machine learning, or other advanced computing applications in an efficient manner, the parallel processor 115 includes a plurality of parallel processing cores (PPCs), such as PPCs 121-1, 121-2, and 121-N (collectively referred to herein as PPCs 121), which are configured to process tasks and offer one or more of GPU functionality and optimized processing for advanced applications that utilize, e.g., reduced precision data common in machine learning. By providing the parallel processor 115 with a plurality of PPCs 121, the parallel processor 115 is able to perform a number of tasks simultaneously while latency and data transfer energy between the PPCs 121 is minimized. The PPCs 121 are typically implemented using shared hardware resources of the parallel processor 115, such as compute units 124. In some embodiments, the PPCs 121 are used to implement shaders, such as geometry shaders, pixel shaders, and the like. Generally, the PPCs 121 are a logical grouping of processing hardware, which in some embodiments includes, e.g., one or more processing chiplets, cores, and/or caches. The PPCs 121 typically include or access a number of compute units 124 in the parallel processor 115, and each of the compute units 124 typically includes a number of single-instruction-multiple-data (SIMD) units. The number of PPCs 121 implemented in the parallel processor 115 is a matter of design choice and some embodiments of the parallel processor 115 include more or fewer PPCs than are shown in FIG. 1.

In the depicted embodiment, each compute unit 124 includes one or more operations registers 125, which are configured to store data elements and intermediate results during execution of operations, such as the transposition of matrices formatted in the FP6 data format. In this and other embodiments, each operations register 125 may be, as non-limiting examples, a general-purpose register of the processing unit, a vector general-purpose register (VGPR) of the processing unit, or a tensor core of the processing unit.

In the depicted embodiment, the processing system 100 also includes a CPU 130 that is connected to the bus 110 through which it communicates with the parallel processor 115 and the memory 105. The CPU 130 implements a plurality of processor cores 131, 132, 133 (collectively referred to herein as “processor cores 131-133”) that execute instructions concurrently or in parallel. The number of processor cores 131-133 implemented in the CPU 130 is a matter of design choice and some embodiments include more or fewer processor cores than are illustrated in FIG. 1. The processor cores 131-133 execute instructions such as program code 125 stored in the memory 105 and the CPU 130 stores information in the memory 105 such as the results of the executed instructions. The CPU 130 is also able to initiate graphics or other processing by issuing draw calls or other tasks to the parallel processor 115.

In the depicted embodiment, the PPCs 121 each include a command processor (CP) 126, such as CPs 126-1, 126-2, and 126-N, to manage and facilitate execution of incoming instructions or tasks. Tasks are stored in a task queue 128 in the memory 105, which also stores dependency information related to the tasks. In some embodiments, the task queue 128 is duplicated or instead stored in the parallel processor 115 and/or CPU 130. Generally, the task queue 128 is stored in a location accessible by the CPU 130 and the parallel processor 115 so that the status of the tasks and dependency information in the task queue 128 can be monitored and new tasks and dependency information can be added as needed by, e.g., the CPU 130 or the parallel processor 115. In some embodiments, the task queue 128 is implemented as a circular buffer with associated read and write pointers, but in other embodiments the task queue 128 takes other forms such as an ordered list or cache.

As shown in FIG. 1, the parallel processor 115 further includes a scheduler 112, which is implemented as any cooperating collection of hardware, software, or a combination thereof that performs functions and computations associated with assigning threads, workgroups, waves, or other tasks, such as compute shader threads, to one or more of the PPCs 121. In some embodiments, one or more of the PPCs 121 are able to be selectively addressed or controlled independently from one another or addressed or controlled in groups of two or more such that the parallel processor 115, the scheduler 112, and/or a user is able to control which PPCs 121 perform specific tasks or to distribute tasks across a number of PPCs 121.

In some embodiments, the parallel processor 115 is used for general purpose computing. For example, the operations registers 125 may be employed for processing tasks involving FP6 data formats, enabling efficient handling of matrix data elements during transposition and loading operations. These registers allow for streamlined rearrangement and alignment of FP6 data directly in the compute units 124, minimizing the need for external memory access and ensuring alignment with the execution resources of the compute units 124. The parallel processor 115 executes instructions such as program code 125 stored in the memory 105 based on dependency information stored in the task queue 128, and the parallel processor 115 stores information in the memory 105 such as the results of the executed instructions, new dependency information for tasks, and indications that dependencies have been satisfied, e.g., when tasks associated with dependency information have finished executing.

In some embodiments, the scheduler 112 and the CPs 126 work together or in parallel to process tasks and dependency information from the task queue 128. For example, in some embodiments, the scheduler 112 assigns tasks to the compute units 124, and the compute units 124 interface with the task queue 128 to determine when tasks can be executed out of order based on dependency information specified in the task queue 128. In some embodiments, the scheduler 112 interfaces with the task queue 128 to determine which tasks to assign to the compute units 124 based on the dependency information. Accordingly, in some embodiments, the scheduler 112 and compute units 124 work together to ensure maximum parallelization and optimized throughput of task execution in the parallel processor 115.

In the example of FIG. 1, an input/output (I/O) engine 145 handles input or output operations associated with the display 120, as well as other elements of the processing system 100 such as keyboards, mice, printers, external disks, and the like. The I/O engine 145 is coupled to the bus 110 so that the I/O engine 145 communicates with the memory 105, the parallel processor 115, or the CPU 130. The I/O engine 145 reads information stored on an external storage component 150, which is implemented using a non-transitory computer readable medium such as a compact disc (CD), a digital video disc (DVD), and the like. The I/O engine 145 is also able to write information to the external storage component 150, such as the results of processing by the parallel processor 115 or the CPU 130.

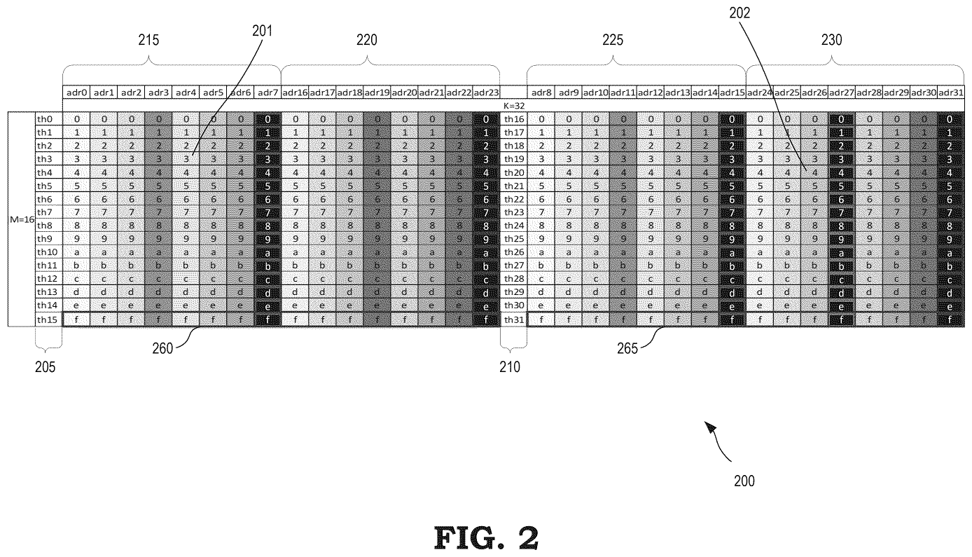

FIG. 2 illustrates an example of a matrix 200 comprising data elements formatted in the FP6 data format, representing an initial layout of the matrix in memory (e.g., memory 105 of FIG. 1). In this example, the matrix 200 has dimensions M=16 rows and K=32 columns, with each element of the matrix 200 represented as an individual FP6 data element.

The matrix 200 is here shown in its initial layout in memory, which in the depicted example is column-major. As used herein, column-major refers to a matrix layout in which elements are stored sequentially by column, such that all elements of a given column are contiguous; conversely, row-major refers to a matrix layout in which elements are stored sequentially by row, such that all elements of a given row are contiguous. Embodiments of techniques described herein perform a transposition operation during the loading of the matrix into the operations registers, rearranging the data elements of the matrix from a column-major layout in memory to a row-major layout in the operations registers (or vice versa). Such transposition is useful, for example, to align the data elements for one or more subsequent processing operations.

Each row of the matrix 200 is assigned to a specific thread for processing. Thread labels 205 correspond to the left half of the matrix 200 (threads th0-th15), while thread labels 210 correspond to the right half of the matrix 200 (threads th16-th31). The matrix data elements are distributed across memory address ranges 215, 220, 225, and 230, which represent distinct portions of memory used to store the matrix. For example, data element 201 is located in address adr4 and assigned to thread th3; data element 202 is located in address adr26 and assigned to thread th20; etc. These memory address ranges are accessed by the threads during processing.

In the depicted example, an optimized thread-to-memory mapping used by the processing unit results in the illustrated arrangement of memory address ranges, which is designed to enhance memory coalescing and minimize contention across memory banks. For example, address range 215 (adr0-adr7) is notably adjacent to address range 220 (adr16-adr23) rather than address range 225 (adr8-adr15). While the specific arrangement depicted is configured to facilitate efficient access to FP6 data elements during processing, it will be appreciated that various thread allocation or memory access patterns associated with various processing units may indicate one or more alternative arrangements in various embodiments and scenarios.

In the depicted example, addresses adr0 through adr31 represent the memory locations from which matrix data is loaded. Each address points to a data block that typically includes multiple FP6 data elements, reflecting how FP6 data is packed and aligned for efficient access. Threads th0 through th31 represent the assigned threads for processing the matrix rows once the matrix 200 is loaded into the operations registers (e.g., operations registers 125 of FIG. 1).

In one example embodiment, the parallel processor 115 of FIG. 1 is implemented as a GPU, and the operations registers 125 are VGPRs associated with the compute units 124. In this embodiment, each VGPR is configured to store a contiguous 96-bit block of matrix data elements. As the matrix 200 is loaded into the VGPRs, its data elements are rearranged such that rows of the column-major matrix 200 in memory are packed into the row-major format required for further computations in the GPU. Specifically, threads th0 through th15 (thread labels 205) may populate one VGPR with the data corresponding to their assigned rows, while threads th16 through th31 (thread labels 210) populate a second VGPR with their respective data. In this example embodiment, this two-VGPR layout allows the matrix 200 to be accessed in a highly parallelized manner, improving utilization of the GPU's execution resources and reducing overhead associated with memory alignment and cache line boundaries.

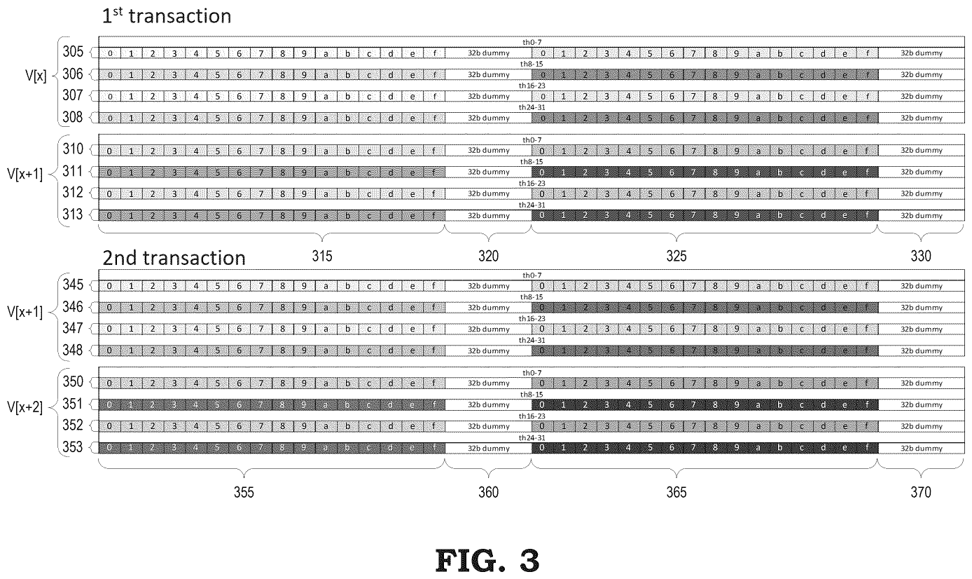

FIG. 3 illustrates part of a two-pass matrix transposition loading operation for a matrix comprising FP6 data elements, such as performed by one or more compute units (e.g., CU 124) within a parallel processor (e.g., parallel processor 115). The matrix data, originally stored in one of a column-major or row-major layout in memory, is transposed into the other of those layouts during its transfer into one or more operations registers (e.g., operations registers 125) for further processing. Continuing the specific example of matrix 200 from FIG. 2, the original matrix data is stored in column-major layout in memory, as shown in FIG. 2, and is to be transposed into row-major layout during the loading process, discussed below with respect to FIGS. 3-5 and elsewhere herein.

In a first transaction, data elements 305-308 and 310-313 represent contiguous rows of retrieved data, with each row corresponding to a specific portion of the matrix. Data elements 305, for example, include portion 315, which corresponds to the adr0 column of the matrix 200 in FIG. 2, and portion 325, which corresponds to the adr1 column of that matrix. Between these data portions are dummy values, such as in padding segments 320 and 330, representing 32-bit alignment padding. Data elements 306-308 similarly include portions corresponding to subsequent columns adr2-adr3 and adr8-adr11 of the matrix 200, interleaved with 32-bit dummy values for alignment. As used herein, a transaction involves the retrieval of a specific subset of matrix data from memory, its transfer to a compute unit, and its organization into the appropriate operations register.

In the first transaction of the depicted example, data elements 305-308 are loaded into a VGPR identified as V[x], while the data elements 310-313 (which include the adr8-adr15 columns of the original matrix 200) are loaded into the VGPR identified as V[x+1].

In the second transaction, data elements 345-348 (corresponding to columns adr16-adr19 in FIG. 2) and 350-353 (corresponding to columns adr20-adr23) correspond to subsequent portions of the matrix, respectively interleaved with 32-bit alignment padding 360 and alignment padding 370. In the depicted embodiment and scenario, the data elements 345-348 are loaded into V[x+1], reusing that VGPR for this transaction, while data elements 350-353 are loaded into V[x+2]. In this manner, all matrix columns are transposed and packed across the VGPRs.

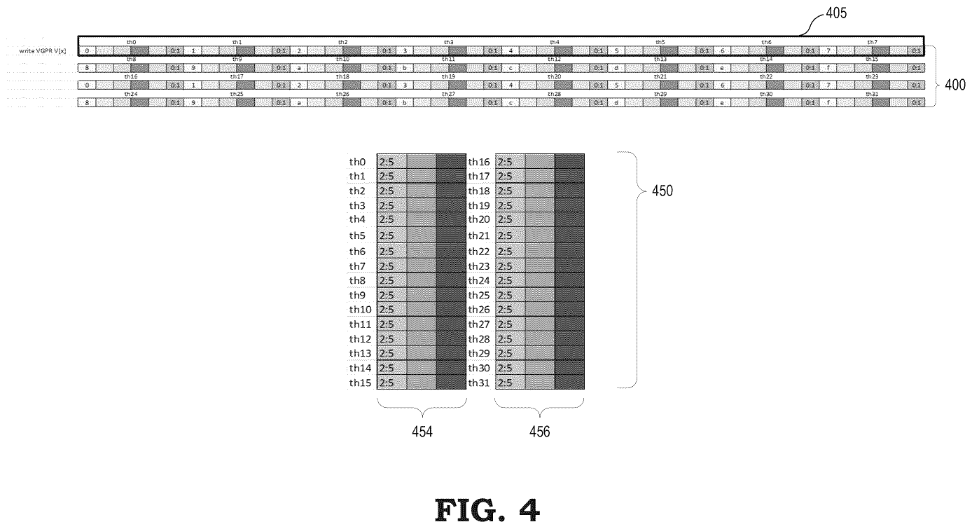

FIG. 4 continues the example of FIGS. 2 and 3 with respect to the loading and transposition operation of the matrix 200, illustrating data reordering and repacking during the first pass of a matrix transposition process within a compute unit. The depicted example shows how portions of data elements from the matrix 200 are partially loaded, reordered, and stored into a VGPR (or other operations register) for further processing, as well as how leftover data from this operation is temporarily stored for use in subsequent operations.

Matrix data 400 is shown as being distributed across multiple threads th0 through th31, with each thread handling specific data elements from the matrix 200. During a first pass, data elements 405 are retrieved, reordered, and packed into one VGPR, labeled here as V[x]. For example, threads th0 through th7 contribute to contiguous sections of this VGPR, with specific data elements arranged according to the (in this example) row-major format. Similar contributions are made by threads th8 through th15, th16 through th23, and th24 through th31, such that each group of threads processes its allocated portion of the data. At the edges of the matrix, portions of certain FP6 data elements are distributed across bit positions, such as bit0 and bit1 (e.g., labeled 0:1) and bit2 through bit5 (e.g., labeled 2:5), within blocks 454 and 456. This ensures that all FP6 data elements are accounted for and properly aligned during the transposition and loading process.

In the depicted example, leftover matrix data 454, 456 from the first pass is temporarily stored in temporary storage elements (e.g., flip-flops or “flops,” latches, etc., not shown). Each thread (e.g., th0, th1, etc.) is responsible for processing a specific subset of the matrix data that are temporarily stored for future operations, with a range of data elements (elements 2:5 in this example) assigned to a given thread th0-th31. For instance, thread th0 stores data elements 2:5 (data elements 2, 3, 4, and 5) from its assigned portion of the matrix data 454, 456. Each thread, from th0 to th31, retains a portion of the matrix data that will be used during subsequent transactions to complete the transposition operation and loading of the transposed matrix in the VGPRs. This temporary storage allows the matrix to be fully transposed and packed without additional memory fetches.

In certain embodiments, the data reordering and repacking process shown in FIG. 4 is performed by functional logic within the compute unit. This logic selects the required data elements from memory or intermediate storage, rearranges them to conform to the row-major format, and writes them to the appropriate VGPRs. The leftover data elements 454, 456 stored in flops represent an intermediate stage in which such leftover data is preserved for subsequent operations.

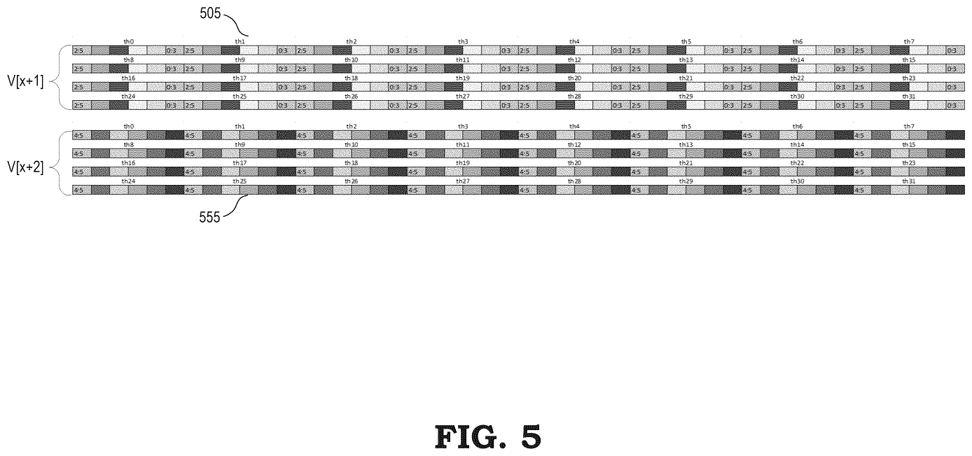

FIG. 5 continues the example of FIGS. 2 and 3 with respect to the loading and transposition operation of the matrix 200, illustrating the data combination process during the second pass of the matrix transposition operation, and highlighting how data stored from the first pass is merged with new data retrieved during the second pass to complete the matrix layout in the VGPRs targeted to store the resulting transposed matrix. In this manner, matrix data originally stored in column-major layout in memory is fully transposed into row-major layout within the VGPRs. In the depicted embodiment, data elements of the matrix 200 are written into two VGPRs during the second pass, respectively identified as V[x+1] and V[x+2].

In the upper portion of the figure, each row of data 505 represents the contributions of specific threads (e.g., th0 through th31) to VGPR V[x+1]. This operation combines data elements previously stored in flops during the first pass (leftover data elements 454, 456) with data elements newly retrieved from memory (e.g., elements 0:3) during the second pass. The merging of these data elements packs and aligns the data elements into the VGPR V[x+1], with each thread contributing its designated range of matrix elements.

Similarly, in the lower portion of the figure, each row of data 555 represents the contributions of specific threads to the VGPR V[x+2]. As with data 505, this operation combines data elements previously stored in flops during the first pass (leftover data elements 454, 456) with data elements newly retrieved from memory (e.g., elements 0:3) during the second pass. The merging of these data elements packs and aligns the data elements into the VGPR V[x+2]. Each thread again contributes its assigned portion of the matrix, ensuring that the row-major layout is finalized as the transposed matrix is stored in the operations registers VGPR V[x+1] and VGPR V[x+2].

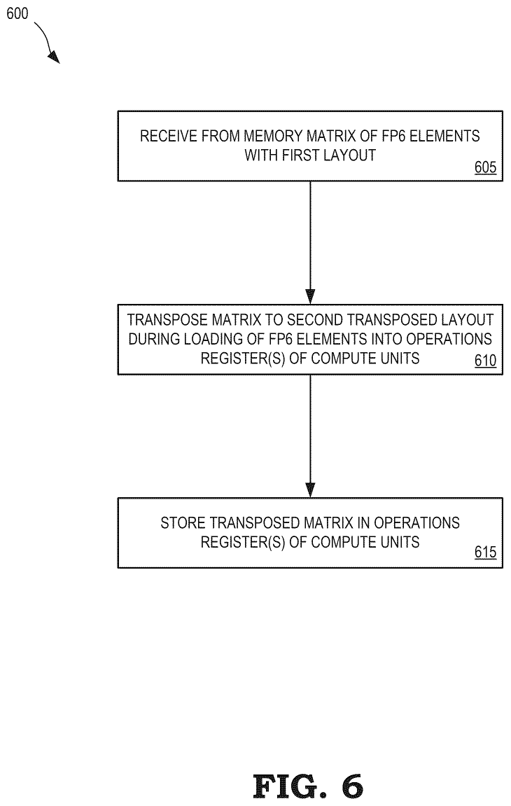

FIG. 6 illustrates an operational routine 600 for transposing and loading a matrix comprising FP6 data elements into operations registers for subsequent operations, in accordance with some embodiments. The operational routine 600 may be performed, for example, by a parallel processor (e.g., parallel processor 115 of FIG. 1) having one or more compute units (e.g., CUs 124).

At step 605, the routine begins by receiving a matrix of FP6 elements from a memory associated with a processing unit. The matrix has an initial layout, such as a row-major layout or a column-major layout, depending on how the data is organized in memory. In some scenarios, the memory comprises a plurality of cache lines, and certain data elements of the matrix may be partially stored across multiple cache lines.

At step 610, a transposition operation is performed during the loading of the matrix into operations registers of the compute units. This operation rearranges the data elements from the received matrix into a transposed layout, such as converting from column-major to row-major or vice versa. To handle cases where data elements are partially stored across multiple cache lines, the process includes caching at least some of these elements locally within the processing unit. The cached data is combined with subsequently received data to ensure alignment and completeness of the matrix during the transposition process, reordering and packing the matrix data into a format optimized for subsequent computations.

At step 615, the transposed matrix is stored in the operations registers of the compute units. These registers provide high-speed access to the fully transposed data, enabling efficient execution of operations that utilize the transposed matrix, such as linear algebra computations or machine learning workloads.

In some embodiments, the apparatus and techniques described above are implemented in a system including one or more integrated circuit (IC) devices (also referred to as integrated circuit packages or microchips), such as the processing system and matrix transposition loading operations described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disk, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

One or more of the elements described above is circuitry designed and configured to perform the corresponding operations described above. Such circuitry, in at least some embodiments, is any one of, or a combination of, a hardcoded circuit (e.g., a corresponding portion of an application specific integrated circuit (ASIC) or a set of logic gates, storage elements, and other components selected and arranged to execute the ascribed operations), a programmable circuit (e.g., a corresponding portion of a field programmable gate array (FPGA) or programmable logic device (PLD)), or one or more processors executing software instructions that cause the one or more processors to implement the ascribed actions. In some embodiments, the circuitry for a particular element is selected, arranged, and configured by one or more computer-implemented design tools. For example, in some embodiments the sequence of operations for a particular element is defined in a specified computer language, such as a register transfer language, and a computer-implemented design tool selects, configures, and arranges the circuitry based on the defined sequence of operations.

Within this disclosure, in some cases, different entities (which are variously referred to as “components,” “units,” “devices,” “circuitry,” etc.) are described or claimed as “configured” to perform one or more tasks or operations. This formulation—[entity] configured to [perform one or more tasks]—is used herein to refer to physical structure (e.g., electronic circuitry). More specifically, this formulation is used to indicate that this physical structure is arranged to perform the one or more tasks during operation. Such physical structure can be said to be “configured to” perform some task even if the structure is not currently being operated. A “memory device configured to store data” is intended to cover, for example, an integrated circuit that has circuitry that stores data during operation, even if the integrated circuit in question is not currently being used (e.g., a power supply is not connected to it). Thus, an entity described or recited as “configured to” perform some task refers to something physical, such as a device, circuitry, memory storing program instructions executable to implement the task, etc. This phrase is not used herein to refer to something intangible. Further, the term “configured to” is not intended to mean “configurable to.” An unprogrammed field programmable gate array, for example, would not be considered to be “configured to” perform some specific function, although it could be “configurable to” perform that function after programming. Additionally, reciting in the appended claims that a structure is “configured to” perform one or more tasks is expressly intended not to be interpreted as having means-plus-function elements.

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
receiving, from a memory of a processing unit, a matrix having one of a row-major layout or a column-major layout and comprising data elements having a 6-bit floating-point (FP6) data format;
performing a transposition operation during a loading of the matrix into an operations register of the processing unit, the transposition operation comprising rearranging the data elements of the received matrix into a transposed matrix having the other of the row-major layout or the column-major layout; and
storing the transposed matrix in the operations register of the processing unit.

2. The method of claim 1, wherein the memory comprises a plurality of cache lines,
wherein receiving the matrix comprises receiving one or more data elements that are partially stored across multiple cache lines of the plurality of cache lines, and wherein the transposition operation comprises:
caching at least some of the partially stored data elements, and
combining the cached at least some of the partially stored data elements with subsequently received data to complete the transposition operation.

3. The method of claim 1, wherein the operations register of the processing unit is one of a group that comprises a general-purpose register of the processing unit, a vector general-purpose register (VGPR) of the processing unit, or a tensor core of the processing unit.

4. The method of claim 3, wherein the processing unit is a graphics processing unit (GPU), and wherein the operations register of the processing unit is a vector general-purpose register (VGPR) of the GPU.

5. The method of claim 1, wherein the transposition operation comprises:
retrieving a first subset of matrix data elements from memory during a first pass;
retrieving a second subset of matrix data elements during a second pass; and combining the first subset and the second subset into the transposed matrix.

6. The method of claim 1, wherein the transposition operation comprises interleaving alignment padding between two or more subsets of the data elements.

7. The method of claim 1, wherein performing the transposition operation comprises loading a subset of columns from the received matrix into respective continuous row segments of the transposed matrix in the operations register.

8. A system comprising:
a memory to store a matrix that has one of a row-major layout or a column-major layout and comprises data elements having a 6-bit floating-point (FP6) data format;
a processing unit coupled to the memory and having a plurality of operations registers, the processing unit to:
receive the matrix from the memory;
transpose the matrix while loading the matrix into one or more of the operations registers, wherein to transpose the matrix comprises rearranging the data elements of the received matrix into a transposed matrix having the other of the row-major layout or the column-major layout; and
storing the transposed matrix in the one or more operations registers.

9. The system of claim 8, wherein the memory comprises a plurality of cache lines,
wherein to receive the matrix comprises receiving one or more data elements that are partially stored across multiple cache lines of the plurality of cache lines, and wherein to transpose the matrix comprises:
caching at least some of the partially stored data elements, and
combining the cached at least some of the partially stored data elements with subsequently received data to generate the transposed matrix.

10. The system of claim 8, wherein each of the one or more operations registers is one of a group that comprises a general-purpose register of the processing unit, a vector general-purpose register (VGPR) of the processing unit, or a tensor core of the processing unit.

11. The system of claim 10, wherein the processing unit is a graphics processing unit (GPU), and wherein the operations register of the processing unit is a vector general-purpose register (VGPR) of the GPU.

12. The system of claim 8, wherein to transpose the matrix includes to:
retrieve a first subset of matrix data elements from memory during a first pass;
retrieve a second subset of matrix data elements during a second pass; and combine the first subset and the second subset into the transposed matrix.

13. The system of claim 8, wherein to transpose the matrix comprises interleaving alignment padding between two or more subsets of the data elements.

14. The system of claim 8, wherein to transpose the matrix comprises loading a subset of columns from the received matrix into respective continuous row segments of the transposed matrix in the one or more operations registers.

15. A non-transitory computer-readable medium storing a set of executable instructions, the set of executable instructions to manipulate at least one processor to:
receive, from a memory of a processing unit, a matrix having one of a row-major layout or a column-major layout and comprising data elements having a 6-bit floating-point (FP6) data format;
perform a transposition operation during a loading of the matrix into an operations register of the processing unit, the transposition operation comprising rearranging the data elements of the received matrix into a transposed matrix having the other of the row-major layout or the column-major layout; and
store the transposed matrix in the operations register of the processing unit.

16. The non-transitory computer-readable medium of claim 15, wherein the memory comprises a plurality of cache lines, wherein receiving the matrix comprises receiving one or more data elements that are partially stored across multiple cache lines of the plurality of cache lines, and wherein the transposition operation comprises:
caching at least some of the partially stored data elements, and
combining the cached at least some of the partially stored data elements with subsequently received data to complete the transposition operation.

17. The non-transitory computer-readable medium of claim 15, wherein the operations register of the processing unit is one of a group that comprises a general-purpose register of the processing unit, a vector general-purpose register (VGPR) of the processing unit, or a tensor core of the processing unit.

18. The non-transitory computer-readable medium of claim 17, wherein the processing unit is a graphics processing unit (GPU), and wherein the operations register of the processing unit is a vector general-purpose register (VGPR) of the GPU.

19. The non-transitory computer-readable medium of claim 15, wherein the transposition operation comprises:
retrieving a first subset of matrix data elements from memory during a first pass;
retrieving a second subset of matrix data elements during a second pass; and combining the first subset and the second subset into the transposed matrix.

20. The non-transitory computer-readable medium of claim 15, wherein the transposition operation comprises interleaving alignment padding between two or more subsets of the data elements.
